(19) United States
(12) Patent Application Publication
(10) Pub. No.: US 2022/0107859 A1
(43) Pub. Date: Apr. 7, 2022

(54) METHOD AND SYSTEM FOR DETERMINING ROOT CAUSE OF ANOMALOUS EVENTS

(71) Applicants: Divya Choudhary, Bangalore (IN); Saurav Daga, Bangalore (IN); Murali Tharan Gnanamani, Bangalore (IN); Robert Peter Hurley, III, Knoxville, TN (US); Brian Morris, Maryville, TN (US); Sven Zuehlsdorff, Oak Brook, IL (US)

(72) Inventors: Divya Choudhary, Bangalore (IN); Saurav Daga, Bangalore (IN); Murali Tharan Gnanamani, Bangalore (IN); Robert Peter Hurley, III, Knoxville, TN (US); Brian Morris, Maryville, TN (US); Sven Zuehlsdorff, Oak Brook, IL (US)

(21) Appl. No.: 17/062,189

(22) Filed: Oct. 2, 2020

(51) Int. Cl. G06F 11/07; G06F 11/30; G06F 11/32

(52) U.S. Cl. CPC G06F 11/079; G06F 11/0772; G06F 2201/80; G06F 11/327; G06F 11/3072; G06F 11/3034

(57) ABSTRACT

A root cause associated with an anomalous event in a device is determined. A method includes retrieving one or more event records associated with the device from a database. The method further includes determining a risk category associated with the one or more event records based on information present in the one or more event records. The risk category indicates a risk associated with a functioning of the device. Additionally, the method includes determining a priority associated with each of the one or more event records based on a baseline associated with the one or more event records. The baseline is defined based on a set of events that occur during a normal functioning of the device. The method includes determining the root cause associated with the anomalous event in the device based on the risk category and the priority associated with the event records.

### FIELD OF TECHNOLOGY

The present disclosure relates to the field of analysis of event records and, more particularly, to the field of determining a root cause of anomalous events in a system.

### BACKGROUND

Systems such as medical scanners generate a plurality of machine logs. Such logs are records of events that may have occurred in the system and include information associated with such events. The event records may also be indicators of anomalous events or defects that arise in the system. The event records are, however, generated in large numbers. Therefore, identifying a root cause of the anomalous events from the event records may be difficult and time consuming. Additionally, the event records may include complex information that may not be readable or understandable by a user. For example, the event records may include technical keywords associated with the system that may be difficult for the user to understand. Therefore, identification of event records associated with the anomalous event may not be straightforward and thereby lead to difficulty in identifying the cause of bug in the system. Further, the event records cannot be annotated using manual effort to distinguish between normal and anomalous events occurring in the system.

### SUMMARY AND DESCRIPTION

There is a need for a method and a system to determine a root cause of anomalous events in a system by effectively managing event records and prioritizing the anomalous event for the event records.

The present embodiments may obviate one or more of the drawbacks or limitations in the related art. For example, a method and a system to determine a root cause of anomalous events in a system are provided.

A method, device, and system for determining a root cause associated with an anomalous event is disclosed. In one aspect, the method includes retrieving one or more event records associated with a device from a database, where the event records include data associated with a functioning of the device. At least one of the one or more event records is associated with the anomalous event. The method also includes determining a risk category associated with the one or more event records based on an information present in the one or more event records, where the risk category indicates a risk associated with the functioning of the device. Additionally, the method includes determining a priority associated with each of the one or more event records based on a baseline associated with the event records, where the baseline is defined based on a set of events that occur during a normal functioning of the device. Further, the method includes determining the root cause associated with the anomalous event in the device based on the risk category and the priority associated with the event records.

In another aspect, a device for determining a root cause associated with an anomalous event includes a processing unit and a memory coupled to the processing unit. The memory includes a root cause identification module configured for retrieving one or more event records associated with the device from a database, where the event records include data associated with a functioning of the device. At least one of the one or more event records is associated with the anomalous event. The root cause identification module is further configured for determining a risk category associated with the one or more event records based on an information present in the one or more event records. The risk category indicates a risk associated with the functioning of the device. Further, the root cause identification module is configured for determining a priority associated with each of the one or more event records based on a baseline associated with the event records. The baseline is defined based on a set of events that occur during a normal functioning of the device. Additionally, the root cause identification module is configured for determining the root cause associated with the anomalous event in the device based on the risk category and the priority associated with the event records.

In another aspect, a system for determining a root cause associated with an anomalous event includes one or more servers and a device communicatively coupled to the servers. The servers include one or more instructions that, when executed, cause the server to retrieve one or more event records associated with the device from a database. The event records include data associated with a functioning of the device, where at least one of the one or more event records is associated with the anomalous event. The instructions further cause the servers to determine a risk category associated with the one or more event records based on information present in the one or more event records. The risk category indicates a risk associated with the functioning of the device. Further, the instructions cause the servers to compute a priority associated with each of the one or more event records based on a baseline associated with the event records. The baseline is defined based on a set of events that occur during a normal functioning of the device. Additionally, the instructions cause the server to determine the root cause associated with the anomalous event in the device based on the risk category and the priority associated with the event records.

In yet another aspect, a non-transitory computer-readable storage medium having machine-readable instructions stored therein is provided. When executed by the server, the machine-readable instructions cause the server to perform the method acts as described above.

This summary is provided to introduce a selection of concepts in a simplified form that are further described below in the following description. The summary is not intended to identify features or essential features of the claimed subject matter. Further, the claimed subject matter is not limited to implementations that solve any or all disadvantages noted in any part of this disclosure.

### BRIEF DESCRIPTION OF THE DRAWINGS

FIG. 1 illustrates a block diagram of a client-server architecture that provides a geometric modeling of components representing different parts of a real-world object, according to an embodiment.

FIG. 2 illustrates a block diagram of a device in which an embodiment of a method for determining a root cause associated with an anomalous event may be implemented.

FIG. 3 illustrates a flowchart of a method for determining the root cause associated with an anomalous event in a device, according to an embodiment.

FIG. 4 illustrates a flowchart of a method of determining the baseline associated with the one or more event records, according to an embodiment.

FIG. 5 illustrates a flowchart of a method for identification of a normal event occurring in the device, according to an embodiment.

FIG. 6 illustrates a flowchart of a method for determining the risk category associated with the event records, according to an embodiment.

FIG. 7 illustrates a risk matrix associated with the event records, according to an embodiment.

FIG. 8 illustrates an exemplary embodiment of an implementation.

### DETAILED DESCRIPTION

Hereinafter, embodiments for carrying out the present invention are described in detail. The various embodiments are described with reference to the drawings, where like reference numerals are used to refer to like elements throughout. In the following description, for purpose of explanation, numerous specific details are set forth in order to provide a thorough understanding of one or more embodiments. It may be evident that such embodiments may be practiced without these specific details. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. There is no intent to limit the disclosure to the particular forms disclosed, but on the contrary, the disclosure is to cover all modifications, equivalents, and alternatives falling within the spirit and scope of the present disclosure.

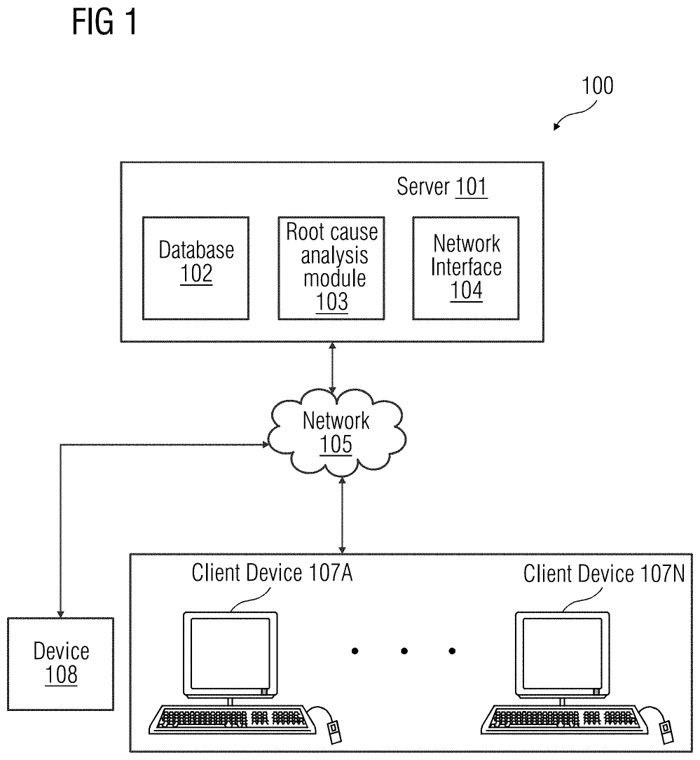

FIG. 1 provides an illustration of a block diagram of a client-server architecture that is a geometric modelling of components representing different parts of real-world objects, according to an embodiment. The client-server architecture 100 includes a server 101 and a plurality of client devices 107A-N. Each of the client device 107A-N is connected to the server 101 via a network 105 (e.g., local area network (LAN), wide area network (WAN), WiFi, etc.). In one embodiment, the server 101 is deployed in a cloud determining environment. As used herein, “cloud determining environment” refers to a processing environment including configurable determining physical and logical resources (e.g., networks, servers, storage, applications, services, etc.) and data distributed over the network 105 (e.g., the Internet). The cloud determining environment provides on-demand network access to a shared pool of the configurable determining physical and logical resources. The server 101 may include a database 102 that is a repository of information related to one or more events that may occur in a device 108. The server 101 may include a root cause identification module 103 that is configured to determine a root cause associated with an anomalous event in the device 108. Additionally, the server 101 may include a network interface 104 for communicating with the client device 107A-N via the network 105.

The client device 107A-N are user devices used by users (e.g., a technician, etc.). In an embodiment, the user device 107A-N may be used by the user to receive data associated with the device 108. The data may be accessed by the user via a graphical user interface of an end user web application on the user device 107A-N. In another embodiment, a request may be sent to the server 101 to access the data associated with the device 108 via the network 105. The device 108 may be connected to the server 101 through the network 105. The device 108 may be a medical imaging unit 108 capable of acquiring a plurality of medical images. The medical imaging unit 108 may be, for example, a scanner unit such as a computed tomography imaging unit, a molecular imaging unit, an X-ray fluoroscopy imaging unit, a magnetic resonance imaging unit, an ultrasound imaging unit, etc. Alternatively, the device 108 may be any equipment or apparatus configured to perform one or more functions as instructed.

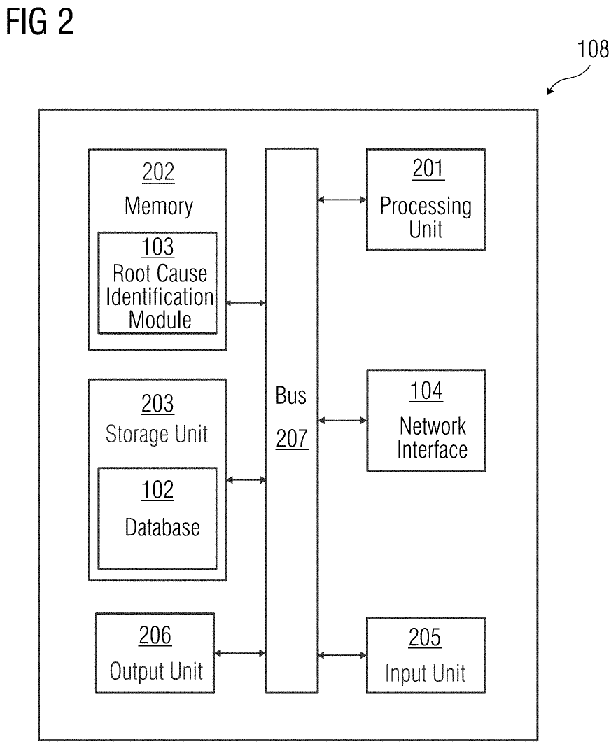

FIG. 2 is a block diagram of the device 108 in which an embodiment may be implemented, for example, as a device to determine a root cause associated with an anomalous event, configured to perform the processes as described therein. In FIG. 2, the device 108 includes a processing unit 201, a memory 202, a storage unit 203, a network interface 104, an input unit 205, an output unit 206, and a standard interface or bus 207.

The processing unit 201, as used herein, may be any type of computational circuit, such as, but not limited to, a microprocessor, microcontroller, complex instruction set determining microprocessor, reduced instruction set determining microprocessor, very long instruction word microprocessor, explicitly parallel instruction determining microprocessor, graphics processor, digital signal processor, or any other type of processing circuit. The processing unit 201 may also include embedded controllers, such as generic or programmable logic devices or arrays, application specific integrated circuits, single-chip computers, and the like. In general, a processing unit 201 may include hardware elements and software elements. The processing unit 201 may be configured for multithreading (e.g., the processing unit 201 may host different calculation processes at the same time, executing in parallel or switching between active and passive calculation processes).

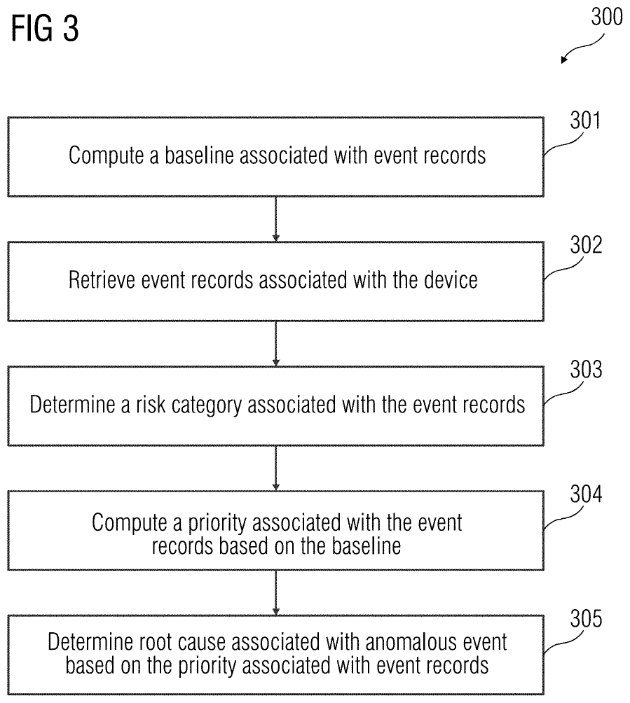

The memory 202 may be volatile memory and non-volatile memory. The memory 202 may be coupled for communication with the processing unit 201. The processing unit 201 may execute instructions and/or code stored in the memory 202. A variety of computer-readable storage media may be stored in and accessed from the memory 202. The memory 202 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes a root cause identification module 103 stored in the form of machine-readable instructions on any of the above-mentioned storage media and may be in communication to and executed by processing unit 201. When executed by the processing unit 201, the root cause identification module 103 causes the processing unit 201 to determine a root cause associated with an anomalous event. Method acts executed by the processing unit 201 to achieve the abovementioned functionality are elaborated upon in detail in FIGS. 3, 4, 5 and 6.

The storage unit 203 may be a non-transitory storage medium that stores a database 102. The database 102 is a repository of information related to one or more events that may occur in the device 108. The input unit 205 may include one or more inputs such as, for example, a keypad, a touch-sensitive display, a camera (e.g., a camera receiving gesture-based inputs), etc. capable of receiving input signal. The bus 207 acts as an interconnect between the processing unit 201, the memory 202, the storage unit 203, the network interface 104, the input unit 205 and the output unit 206.

Those of ordinary skilled in the art will appreciate that the hardware depicted in FIG. 2 may vary for particular implementations. For example, other peripheral devices such as an optical disk drive and the like, Local Area Network (LAN)/ Wide Area Network (WAN)/ Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

A device in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response, may be performed.

One of various commercial operating systems, such as a version of Microsoft Windows™, a product of Microsoft Corporation located in Redmond, Wash., may be employed if suitably modified. The operating system is modified or created in accordance with the present disclosure as described.

Disclosed embodiments provide systems and methods for analyzing event records. For example, the systems and methods may determine a root cause associated with an anomalous event.

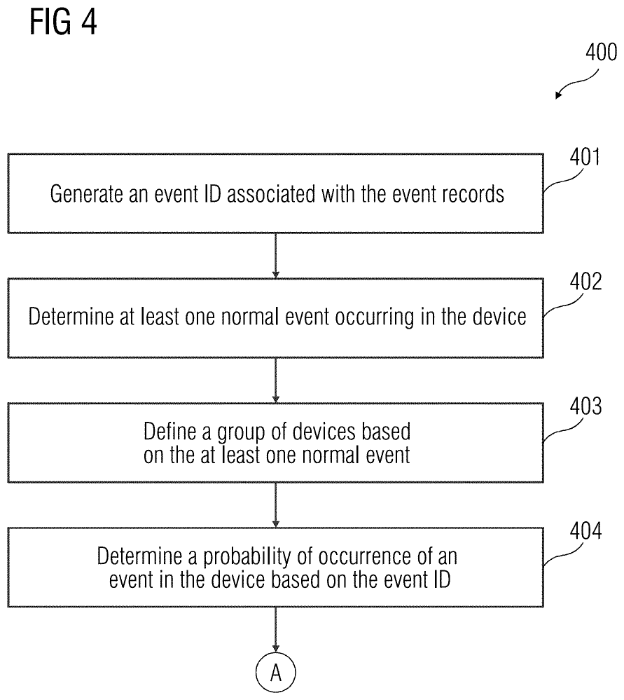

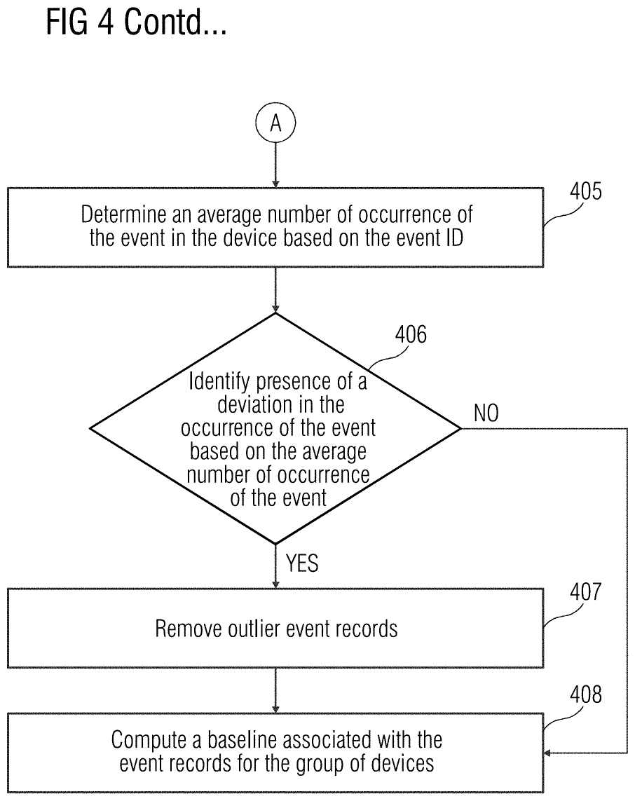

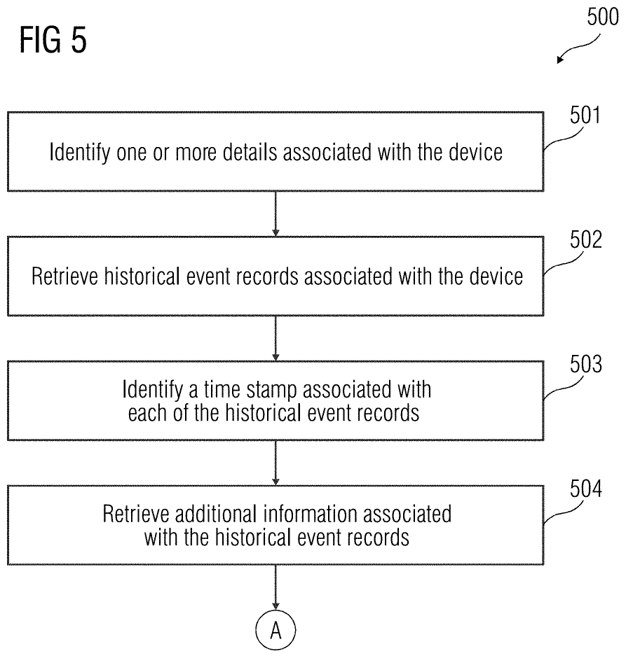

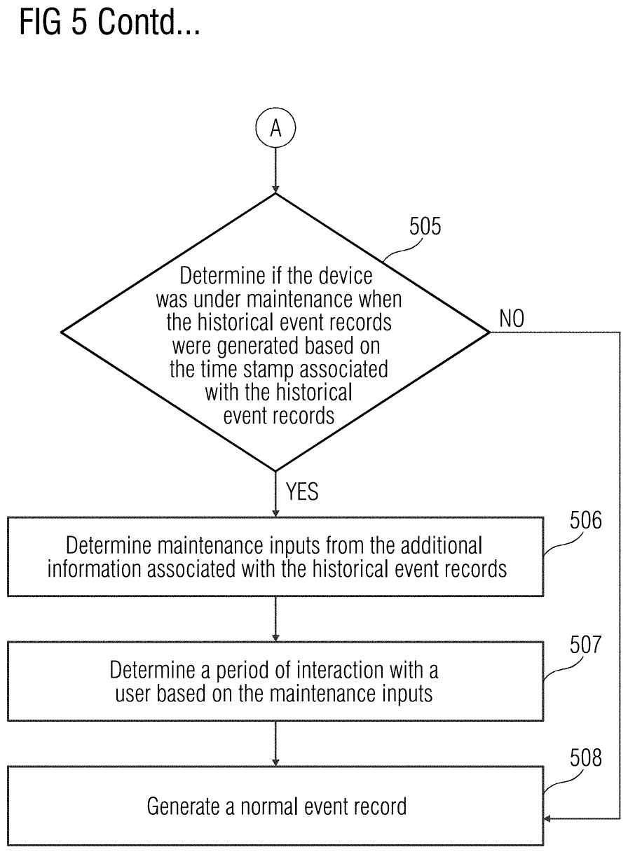

FIG. 3 illustrates a flowchart of an embodiment of a method 300 for determining a root cause associated with an anomalous event in a device 108 according to an embodiment. At act 301, a baseline associated with event records is computed. Event records include data associated with events that may occur in a device 108 during functioning of the device 108. The event records may include information (e.g., errors, warnings, general information associated with the functioning of the device 108, etc.). The baseline associated with the event records enables determination of normal behavior of the device 108 (e.g., a behavior of the device 108 during a normal and error-free functioning of the device 108). Therefore, the baseline associated with the event records may be a threshold based on which an anomalous event occurring in the device 108 may be identified. The method acts illustrating determining of the baseline is disclosed in further detail in FIGS. 4 and 5.

Referring to FIG. 4, the method 400 includes act 401 of generating an event ID associated with the event records. In an embodiment, the event records include a plurality of data such as source application in the device 108 from which the event records is generated, event identifier details, a date and time stamp indicating a time of occurrence of the event, a security level of the event such as, but not limited to, error, warning, general information, etc., and an event message. In an embodiment, the event message may include a variable portion that may vary based on the event that may have occurred in the device 108. The event message may further include a fixed portion that may indicate a nature of the event record (e.g., ‘Internal processing error’). The event ID associated with the event records may include only a portion of the data present in the event record. In a further embodiment, the event ID may include information associated with source application in the device 108 from which the event records is generated and event identifier details. Additionally, the event ID may include the event message present in the event records. For example, the event ID may only include the variable portion of the event message. A natural language processing algorithm may be used to identify relevant information from the variable portion of the event message.

At act 402, at least one normal event occurring in the device 108 is identified. The event records generated for the device 108 may include information associated with events that are known to occur during a normal functioning of the device 108. Such events may be identified as normal events. Since the baseline is a depiction of normal events in the device 108, at least one normal event is identified in the device 108. The method acts for the identification of the at least one normal event is disclosed in further detail in FIG. 5. At act 403, a group of devices is defined based on the at least one normal event. Defining a group of devices enables identification of a baseline based on normal events for all the devices. Therefore, effective root cause analysis may be performed for the anomalous event based on the baseline identified for the group of devices. In an embodiment, the group of devices may be defined based on one or more similarities between the devices. For example, the devices in the group of devices may have a similar product type, similar version of software application installed, similar pattern of usage of device, etc.

At act 404, a probability of occurrence of the event in the device 108 is determined based on the event ID. For example, the probability of the occurrence of the event in the device may be determined in machine days (e.g., in how many days the event may occur in the device 108). In a further embodiment, a statistical distribution associated with occurrence of the event in the device 108 is calculated. The statistical distribution may be, for example, a normal distribution, a lognormal distribution, or an exponential distribution. At act 405, an average number of occurrences of the event in the device 108 is determined based on the event ID. At act 406, a presence of a deviation in the occurrence of the event is identified based on the average number of occurrences of the event in the device 108. The presence of deviation or a low probability value may be an indication of an outlier in the probability of occurrence of the event in the device 108. The outlier may be an event that may not be a part of the normal functioning of the device 108 and therefore, may not be considered in the baseline. For example, a standard deviation and probability of occurrence value may be computed for the occurrence of the event in the device 108. If the presence of a deviation is identified or the probability value is very low, at act 407, one or more event records that may be outliers may be removed. In an embodiment, the outliers may be removed also based on the probability of occurrence of the event in the device 108. Further, at act 408, the baseline associated with the event records for the group of devices is computed based on the normal events identified for the group of devices.

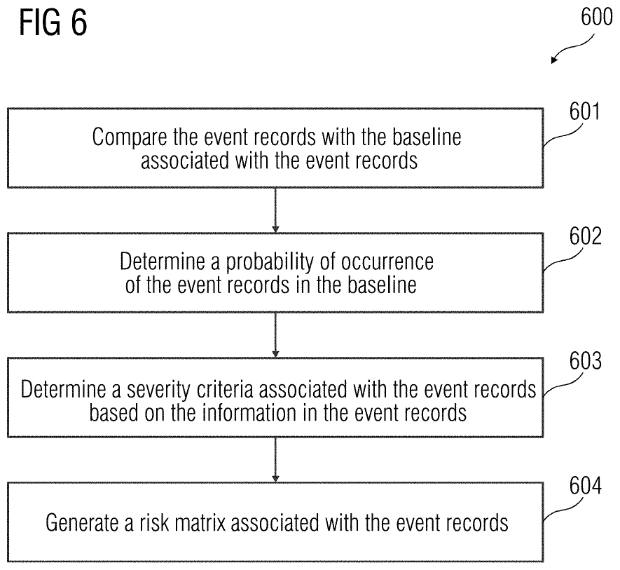

Referring back to FIG. 3, at act 302, one or more event records are retrieved from the database 102. For example, the one or more event records may be associated with one or more events that may occur in real-time in the device 108. At act 303, a risk category associated with the event records is determined. The risk category associated with the event records provide information on severity of the one or more events that may have occurred in the device 108. Determination of risk category may further enable prioritizing of the one or more events in the device 108 for determination of root cause of the event and resolution of the event. The method acts describing determination of the risk category are detailed out in FIG. 6. At act 304, a priority associated with the event records is computed based on the baseline. The priority associated with the event records may indicate a priority with which the event associated with the event record may be resolved. The computation of the priority associated with the event records may be performed by determining a difference between an average occurrence of the event in real-time with the average occurrence of the events as defined in the baseline. Further, this difference is divided by the standard deviation determined for the baseline to identify a deviation in frequency of occurrence of the event in real-time in the device 108. For example, if the average occurrence of the event, as defined in the baseline associated with an event ID, is 10, the standard deviation defined in the baseline is 2, and the average occurrence of event in real-time is 15, the deviation in frequency of occurrence of the event in real-time is

(15−10)/2=2.5σ

(e.g., the average frequency of occurrence of the event in the device 108 in real-time is 2.5 standard deviations away from the baseline for the group of devices). This enables determination of priority associated with the event records for further investigation within a risk category. At act 305, the root cause associated with the anomalous event is determined based on the risk category and the priority associated with the event records.

FIG. 5 illustrates a flowchart of a method 500 of identification of the at least one normal event occurring in the device 108, according to an embodiment. At act 501, one or more details associated with the device 108 are identified. The one or more details associated with the device 108 may include details related to hardware and software versions associated with the device 108. Additionally, the one or more details may also include a time stamp associated with installation of the software version in the device 108, etc. At act 502, historical event records associated with the device 108 are retrieved. The historical event records may be stored in the database 102. The historical event records may be a record of events that may have occurred in the device 108 historically and may include information associated with normal and non-normal events occurred in the device 108. At act 503, a time stamp associated with each of the historical records is identified. The time stamp provides details of a date and time when the historical event may have occurred in the device 108. At act 504, additional information associated with the historical event records may be retrieved. The additional information may include one or more complaints or queries raised by a user of the device 108. Such complaints and/or queries may be related to the historical events that may have occurred in the device 108.

At act 506, it is determined if the device 108 was under maintenance when the historical event records were generated. Such determination may be made based on the time stamp associated with the historical event records. If the device 108 was under maintenance when the historical event records were generated, one or more maintenance inputs are determined from the additional information associated with the historical event records. In an embodiment, the additional information may be derived from the historical event records using natural language processing. The maintenance inputs may include, for example, details associated with interaction of the user of the device 108 with a device maintenance executive. Additionally, the maintenance input may also include any action performed by the user of the device 108 on the device 108 after the occurrence of the historical event in the device 108. Further, a period of interaction with the user of the device 108 is determined at act 507, based on the maintenance inputs. All the historical event records that are generated during the period of interaction are discarded. Therefore, only normal events associated with the device 108 are collected. At act 508, normal event records associated with the normal events occurring in the device 108 is generated based on the identified normal historical records.

FIG. 6 illustrates a flowchart of a method 600 of determination of the risk category associated with an event record, according to an embodiment. At act 601, the real-time event records are compared with the baseline associated with the event records. At act 602, a probability of occurrence of a real-time event associated with the real-time record, in the baseline, is determined. A probability score may be assigned to the real-time event record based on the probability of occurrence of the real-time event record in the baseline. For example, there may be three categories of probability of occurrence, based on which the probability score may be assigned. An embodiment of probability criteria and probability score is provided in a table below.

| Probability category | Criteria of classification | Probability score |
|---|---|---|
| No occurrence | Real-time event record is not | 2 |
| | present in the baseline | |
| Low occurrence | Probability of occurrence by | 1 |
| | machine days < Threshold | |
| | value | |
| High occurrence | Probability of occurrence by | 0 |
| | machine days >= Threshold | |
| | value | |

A threshold value associated with the probability of occurrence may be defined based on a distribution curve associated with the real-time event records. Machine days may be the number of days of occurrence of the event in the device 108.

At act 603, a severity criteria associated with the real-time event records is determined based on the information associated with the real-time event records. The event records include information that may indicate a nature of the event associated with the event record. For example, the event record may include information such as ‘Error’, ‘Warning’ and/or ‘Information’, etc. Such information may be used to determine a severity level of the real-time event records. For each severity level, a severity score may be assigned. An embodiment of severity levels and associated severity scores is provided in the table below.

| Severity level | Severity score |
|---|---|
| Error | 2 |
| Warning | 1 |
| Miscellaneous | 0 |

For example, ‘Miscellaneous’ level may include event records with information such as ‘Information’, ‘Success’, or event records with no information, etc. The severity score may be an indication of the severity of the real-time event record. For example, an event record with severity score 2 has greater severity than an event record with a severity score 1.

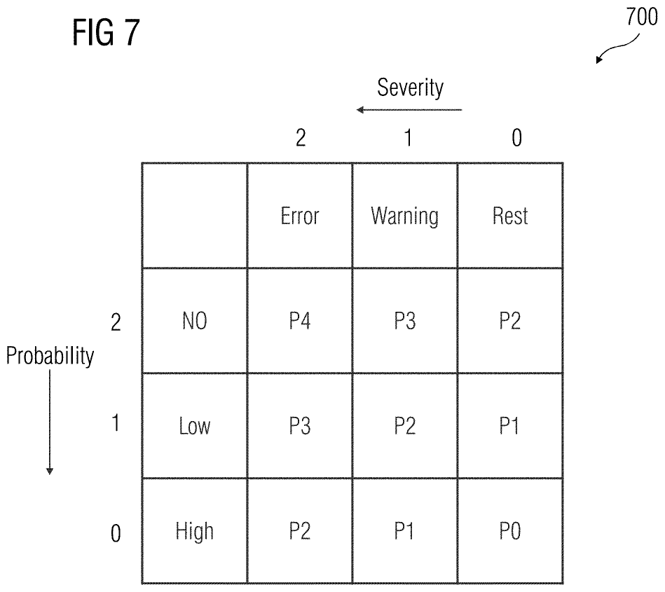

At act 604, a risk matrix associated with the real-time event records is generated. In an embodiment, the risk matrix may be a combination of probability of occurrence of the real-time event and the severity criteria associated with the real-time event. An embodiment of a risk matrix is illustrated in FIG. 7. The risk matrix 700 enables accurate determination of a risk category associated with the real-time event record. For example, an event record with a severity criteria of 2 and a probability score of 2 has the highest risk category. Therefore, as illustrated in matrix 700, an error with a severity criteria 2 that has a no probability of occurrence in the device 108 is assigned the highest risk category (e.g., P4 as the chances of the error occurring in the device 108 is the lowest during a normal functioning of the device 108).

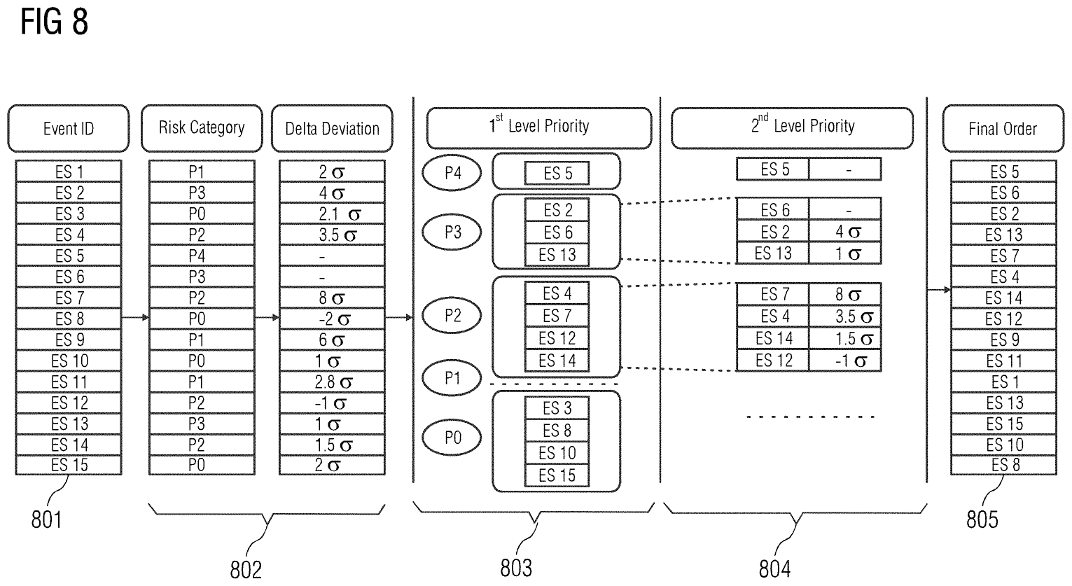

FIG. 8 illustrates an exemplary embodiment of implementation. In the embodiment, it is assumed that a sporadic issue is reported for the device 108. The issue may arise randomly and seldomly. It is further assumed that no data is available on a use case that led to the issue and no additional information on the occurrence of the issue is available. The event records associated with the issue is available in the database 102. The issue may be reproduced in a simulated test environment, and the event records associated with the event may be investigated manually. Reproducing the event in the simulated environment is, however, complicated, as not all details associated with the issue may be captured in the event records. In order to overcome this, the present embodiments may be used to identify the root cause associated with the issue. One or more event IDs associated with the device 108 are obtained, where the event IDs include information associated with the issue and related time stamp of occurrence of the issue. The table 801 in FIG. 8 illustrates the event IDs associated with the device 108. A risk category associated with each of the event IDs and an amount of deviation for each of the event IDs is computed, as depicted in table 802. The risk category is determined based on the probability of occurrence of the issue in the device 108 and the severity associated with the issue. The determination of amount of deviation is made based on the baseline defined for the device 108. The deviation enables determining a priority associated with the event IDs. Further, the event IDs are classified based on the risk category, as depicted in table 803. Therefore, a first level of priority of the event IDs is performed based on the risk category associated with the event IDs. A second level of priority is defined based on the amount of deviation determined for each of the event IDs based on the baseline defined for the device 108. The second level of priority of the event IDs is depicted in table 804. In a further embodiment, event records that have newly occurred will have an infinite deviation. Further, a final order of the event IDs is computed based on the levels of priority such that an investigation of the event IDs may be performed methodically to determine the root cause of the issue in the device 108. The final order of priority of the event IDs is provided in table 805.

An advantage of the present embodiments is that the root cause associated with an event occurring in a device may be identified efficiently. The need for manually analyzing the event records to determine the root cause of the event is eliminated. Additionally, the method enables effective prioritization of the event records for systematic root cause analysis. Further, the method enables determination of not just fatal errors in the device 108 but also minor errors that may affect the functioning of the device 108. The baseline associated with the device 108 may be considered as a gold standard of events that are expected to occur in the device 108. This enables effective segregation of bad events that may occur in the device 108 from the normal events. The method also enables consideration of event records that may have been recorded for a group of devices, thereby enabling effective resolution of the error in the device 108.

The foregoing examples have been provided merely for the purpose of explanation and are in no way to be construed as limiting of the present invention disclosed herein. While the invention has been described with reference to various embodiments, the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods, and uses, such as are within the scope of the appended claims. Those skilled in the art, having the benefit of the teachings of this specification, may effect numerous modifications thereto, and changes may be made without departing from the scope and spirit of the invention in its aspects.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of determining a root cause associated with an anomalous event in a device, the method comprising:
retrieving one or more event records associated with the device from a database, wherein the one or more event records comprise data associated with a functioning of the device, wherein at least one of the one or more event records is associated with the anomalous event;
determining a risk category associated with the one or more event records based on information present in the one or more event records, wherein the risk category indicates a risk associated with the functioning of the device;
determining a priority associated with each of the one or more event records based on a baseline associated with the one or more event records, wherein the baseline is defined based on a set of events that occur during a normal functioning of the device; and
determining the root cause associated with the anomalous event in the device based on the risk category and the priority associated with the one or more event records.

2. The method of claim 1, wherein determining the risk category associated with the one or more event records comprises:
comparing the one or more event records with the baseline associated with the one or more event records;
determining a probability of occurrence of at least one of the one or more event records in the baseline associated with the one or more event records;
determining a severity criteria associated with the one or more event records based on the information in the one or more event records; and
determining a risk score associated with the one or more event records based on the probability of occurrence of the at least one event record in the baseline and the severity criteria associated with the one or more event records,
wherein the risk score provides the risk category associated with the one or more event records associated with the device.

3. The method of claim 2, wherein determining the risk score comprises generating a risk matrix associated with the one or more event records using the probability of occurrence of the one or more event records in the baseline associated with the one or more event records and the severity criteria associated with the one or more event records.

4. The method of claim 1, further comprising determining the baseline associated with the one or more event records.

5. The method of claim 4, wherein determining the baseline associated with the one or more event records comprises:
generating an event ID associated with the one or more event records, wherein the event ID is generated based on the information present in the one or more event records;
determining at least one normal event from the one or more event records, wherein the normal event is an event that occurs during a normal functioning of the device;
defining a group of devices associated with the at least one normal event, wherein the group of devices comprises at least one device; and
determining the baseline associated with the one or more event records for the group of devices based on the at least one normal event associated with the group of devices.

6. The method of claim 5, further comprising:
determining a probability of occurrence of an event in the device based on the event ID;
determining an average number of occurrence of the event in the device based on the event ID; and
identifying a presence of a deviation in the occurrence of the event based on the average number of occurrence of the event in the device.

7. A device for determining a root cause associated with an anomalous event, the device comprising:
one or more processing units;
a memory coupled to the one or more processing units, the memory comprising a root cause identification module configured to:
retrieve one or more event records associated with the system from a database, wherein the one or more event records comprise data associated with a functioning of the device, wherein at least one of the one or more event records is associated with the anomalous event;
determine a risk category associated with the one or more event records based on information present in the one or more event records, wherein the risk category indicates a risk associated with the functioning of the device;
determine a priority associated with each of the one or more event records based on a baseline associated with the event records, wherein the baseline is defined based on a set of events that occur during a normal functioning of the device; and
determine the root cause associated with the anomalous event in the device based on the risk category and the priority associated with the event records.

8. The device of claim 7, wherein in the determination of the risk category associated with the one or more event records, the root cause identification module is configured to:
compare the one or more event records with the baseline associated with the one or more event records;
determine a probability of occurrence of at least one of the one or more event records in the baseline associated with the one or more event records;
determine a severity criteria associated with the one or more event records based on the information in the one or more event records; and
compute a risk score associated with the one or more event records based on the probability of occurrence of the at least one event record in the baseline and the severity criteria associated with the one or more event records.

9. The device of claim 7, wherein the root cause identification module is further configured to compute the baseline associated with the one or more event records.

10. The device of claim 9, wherein in the determination of the baseline associated with the one or more event records, the root cause identification module is configured to:
generate an event ID associated with the one or more event records, wherein the event ID is generated based on the information present in the one or more event records;
determine at least one normal event from the one or more event records, wherein the normal event is an event that occurs during a normal functioning of the device;
define a group of devices associated with the at least one normal event, wherein the group of devices comprises at least one device; and
compute the baseline associated with the one or more event records for the group of devices based on the at least one normal event associated with the devices.

11. The device of claim 10, wherein the root cause identification module is further configured to:
determine a probability of occurrence of an event in the device based on the event ID;
determine an average number of occurrence of the event in the device based on the event ID; and
identify a presence of a deviation in the occurrence of the event based on the average number of occurrence of the event in the device.

12. A system for determining a root cause associated with an anomalous event in a device, the system comprising:
one or more servers; and
a device communicatively coupled to the one or more servers,
wherein the servers comprise one or more instructions, which when executed, cause the servers to:
retrieve one or more event records associated with the device from a database, wherein the event records comprise data associated with a functioning of the device, and wherein at least one of the one or more event records is associated with the anomalous event;
determine a risk category associated with the one or more event records based on information present in the one or more event records, wherein the risk category indicates a risk associated with the functioning of the device;
compute a priority associated with each of the one or more event records based on a baseline associated with the one or more event records, wherein the baseline is defined based on a set of events that occur during a normal functioning of the device; and
determine the root cause associated with the anomalous event in the device based on the category and the priority associated with the event records.

13. In a non-transitory computer-readable storage medium that stores machine-readable instructions executable by a server to determine a root cause associated with an anomalous event in a device, the machine-readable instructions comprising:
retrieving one or more event records associated with the device from a database, wherein the one or more event records comprise data associated with a functioning of the device, and wherein at least one of the one or more event records is associated with the anomalous event;
determining a risk category associated with the one or more event records based on an information present in the one or more event records, wherein the risk category indicates a risk associated with the functioning of the device;
determining a priority associated with each of the one or more event records based on a baseline associated with the one or more event records, wherein the baseline is defined based on a set of events that occur during a normal functioning of the device; and
determining the root cause associated with the anomalous event in the device based on the risk category and the priority associated with the one or more event records.

14. The non-transitory computer-readable storage medium of claim 13, wherein determining the risk category associated with the one or more event records comprises:
comparing the one or more event records with the baseline associated with the one or more event records;
determining a probability of occurrence of at least one event record of the one or more event records in the baseline associated with the event records;
determining a severity criteria associated with the one or more event records based on the information in the one or more event records; and
determining a risk score associated with the one or more event records based on the probability of occurrence of the at least one event record in the baseline and the severity criteria associated with the one or more event records.

15. The non-transitory computer-readable storage medium of claim 14, wherein the machine-readable instructions further comprise determining the baseline associated with the one or more event records.

16. The non-transitory computer-readable storage medium of claim 15, wherein determining the baseline associated with the one or more event records comprises:
generating an event ID associated with the one or more event records, wherein the event ID is generated based on the information present in the one or more event records;
determining at least one normal event from the one or more event records, wherein the normal event is an event that occurs during a normal functioning of the system;
defining a group of systems associated with the at least one normal event, wherein the group of systems comprises at least one system; and
determining the baseline associated with the one or more event records for the group of systems based on the at least one normal event associated with the systems.

17. The non-transitory computer-readable storage medium of claim 16, wherein the machine-readable instructions further comprise:
determining a probability of occurrence of an event in the device based on the event ID;
determining an average number of occurrence of the event in the device based on the event ID; and
identifying a presence of a deviation in the occurrence of the event based on the average number of occurrence of the event in the device.
